(19) United States
(12) Patent Application Publication
(10) Pub. No.: US 2002/0128100 A1
(43) Pub. Date: Sep. 12, 2002

(54) Pivot shaft member for a slide contact guide for transmission medium

(76) Inventors: Kozo Inoue, Osaka (JP); Osamu Ono, Osaka (JP)

Correspondence Address: DANN DORFMAN HERRELL & SKILLMAN, SUITE 720, 1601 MARKET STREET, PHILADELPHIA, PA, 19103-2307, US

(21) Appl. No.: 10/093,629

(22) Filed: Mar. 8, 2002

(30) Foreign Application Priority Data
Mar. 12, 2001 (JP) 069238/2001

(51) Int. Cl. F16H 7/08; F16H 7/18

(52) U.S. Cl. 474/111; 474/140

(57) ABSTRACT

A pivot shaft member is disclosed which can be mounted to a fixed frame such as a frame of a drive unit in a positive and simple manner while correcting a positional deviation, if any, between mounting holes through which the pivot shaft member is inserted, the mounting holes being formed respectively in a lower side wall of a guide body of a slide contact guide for a transmission device as assembled and in a reinforcing plate. The pivot shaft member is provided with a tapered, truncated cone-like guide inserting portion and a cylindrical support portion, the tapered, truncated cone-like guide inserting portion being inserted into the mounting holes while correcting a positional deviation between the mounting holes at the time of mounting the guide to a fixed frame, the cylindrical guide support portion being contiguous to the truncated cone-like guide inserting portion and onto which inner peripheral surfaces of the mounting holes are flushly fitted and supported after the mounting of the guide. With these components, the pivot shaft member can be mounted to the fixed frame in a positive and simple manner while correcting the positional deviation between the mounting holes.

### BACKGROUND OF THE INVENTION

1. Field of the Invention

The present invention relates to a pivot shaft member for mounting a slide contact guide for a transmission medium, such as a tensioner lever or a guide lever, to a fixed frame, with a transmission medium such as a chain or a belt coming into sliding contact with the slide contact guide in a drive unit such as a vehicular engine.

2. Description of the Prior Art

Generally, in a drive unit such as a vehicular engine which transmits power through a transmission medium such as a chain or a belt, there is used a slide contact guide for a transmission medium, such as a movable tensioner lever or a fixed guide lever, which is mounted to a fixed frame such as a frame of the drive unit through a bolt or pin type pivot shaft member, to prevent the occurrence of chordal vibration or rolling of the transmission medium stretched between a driving side and a driven side or prevent an excessive variation of tension, thereby permitting a smooth travel.

As to such a slide contact guide for a transmission medium, various improvements have been made for ensuring durability against vibration and rolling of the transmission medium and against an excessive variation in tension. Improvements have also been made for reducing the weight of the guide. As a conventional example there is known such a plastic guide for a transmission device as shown in FIG. 7, which is described in Japanese Patent Application No. 382798/2000.

In the plastic guide of this 98 patent application, indicated at G, in order to reduce the weight of the guide while ensuring required flexural rigidity and strength and facilitate the assembly and fabrication of the guide, a guide body G3 is formed integrally by molding a synthetic resin, the guide body G3 comprising a shoe G1 with which a travelling chain or belt comes into sliding contact and a lower side wall G2 formed on a back side of the shoe in the shape of a vertical plate extending in the longitudinal direction, and a reinforcing plate G5, which is a steel plate, is fitted into a slit G4 formed in the lower side wall G2 of the guide body G3. In this way the guide G is fabricated. The plastic guide G is mounted to a fixed frame F such as a frame of a drive unit with use of a bolt type pivot shaft member B which is inserted through mounting holes G6 and G7 formed in the guide G.

However, the following new knowledge was obtained. In the conventional plastic guide G for a transmission device, as shown in FIG. 7, since the reinforcing plate G5 is forcibly fitted into the slit G4 formed in the lower side wall G2 which slit is in a grippingly pressurized state, the reinforcing plate is often fitted in the slit while the mounting holes G6 and G7 formed respectively in the lower side wall G2 of the guide body G3 and in the reinforcing plate G5 are out of alignment with each other by an amount corresponding to a positional deviation of X.

As a result, when the plastic guide G with the mounting holes G6 and G7 not aligned by an amount of the positional deviation X is to be mounted to the fixed frame F, the bolt type pivot shaft member B is caught on an inner peripheral edge g of the mounting hole G7 formed in the reinforcing plate G5 and cannot pass through both mounting holes G6 and G7. Before the mounting, therefore, it is necessary that the positional deviation X between the mounting holes G5 and G7 formed in the lower side wall G2 and the reinforcing plate G5 respectively be corrected. Thus, a large mounting burden is imposed on the assembling work.

If the bolt type pivot shaft member B is forced to be inserted through the mounting holes G6 and G7 formed in the plastic guide G, the mounting hole G6 formed in the lower side wall G2 of a synthetic resin will be damaged, with consequent partial wear of the guide G, which may lead to deterioration of the sliding contact function or of the guide life.

Particularly, in the case where the plastic guide G for a transmission device is a movable tensioner lever, there arises, in addition to the above problems, a problem such that a smooth pivoting function around the bolt type pivot shaft member B as fulcrum, which is for following an excessive variation in tension of a travelling chain or belt to adjust the tension, cannot be fulfilled to a satisfactory extent.

### SUMMARY OF THE INVENTION

Accordingly, it is an object of the present invention to solve the above-mentioned problems of the prior art and provide a pivot shaft member for a slide contact guide for a transmission medium, which, when mounted to a fixed frame such as a frame of a drive unit, can correct a positional deviation between mounting holes, thereby permitting a positive and easy installation, and which can ensure its slide contact function and service life over a long period, even in the event there is a positional deviation between mounting holes formed respectively in a lower side wall of a guide body and in a reinforcing plate both assembled together as the guide.

For solving the foregoing problems, in a first aspect of the present invention there is provided a pivot shaft member to be inserted and fixed through mounting holes formed respectively in a longitudinally extending lower side wall of a guide body of a slide contact guide for a transmission medium and in a reinforcing plate for fixing the slide contact guide to a fixed frame, the slide contact guide comprising the guide body and the reinforcing plate, the guide body having an elongated shoe surface with which a travelling transmission medium such as a travelling chain or belt comes into sliding contact, the reinforcing plate being grippingly fitted along and into the lower side wall of the guide body, characterized by including a tapered, truncated cone-like guide inserting portion and a cylindrical guide support portion, the truncated cone-like guide inserting portion being inserted, at the time of mounting the guide, into the mounting holes while correcting a positional deviation between the mounting holes, and the cylindrical guide support portion being contiguous to the truncated cone-like guide inserting portion and onto which inner peripheral surfaces of the mounting holes are flushly fitted and supported after the mounting of the guide.

In a second aspect of the present invention there is provided, in combination with the above first aspect, a pivot shaft member wherein a screw portion smaller in diameter than the truncated cone-like guide inserting portion and adapted to be threadedly engaged with the fixed frame to fix the pivot shaft member is formed on an inserting tip side of the truncated cone-like guide inserting portion.

The pivot shaft member as referred to herein is at least provided with a tapered, truncated cone-like guide inserting portion which is inserted into mounting holes while correcting a positional deviation between the mounting holes and is also provided with a cylindrical guide support portion contiguous to the truncated cone-like guide inserting portion and onto which inner peripheral surfaces of the mounting holes are flushly fitted and supported. As to a concrete shape other than the truncated cone-like guide inserting portion and the cylindrical guide support portion, it may be a bolt or pin shape used as a separated and independent pivot shaft part at the time of mounting or it may be a bolt or pin shape implanted beforehand into the fixed frame.

It is optional whether the slide contact guide for a transmission medium to which the pivot shaft member of the present invention is applied is to be a movable tensioner lever which is for regulating an excessive variation in tension developed in a transmission medium stretched between a driving side and a driven side of a drive unit to permit a smooth travel or a fixed guide lever which is for preventing chordal vibration and rolling of a transmission medium to permit a smooth travel, insofar as the guide is of the type which is mounted to a fixed frame such as a frame of a drive unit through mounting holes formed respectively in the lower side wall of the guide body and in the reinforcing plate. As the material of the guide body, engineering plastics and fiber-reinforced plastics, which are superior in wear resistance and lubricity and which can fulfill the shoe function and attain the reduction of weight to a satisfactory extent, are preferred, but there also may be used other materials. Also as to the material of the reinforcing plate, no special limitation is placed thereon, but ferrous metals, nonferrous metals, engineering plastics, and fiber-reinforced plastics are preferred from the standpoint of flexural rigidity and strength.

According to the pivot shaft member in the first aspect of the present invention, even if there is a positional deviation between mounting holes formed respectively in the lower side wall of the guide body and in the reinforcing plate both assembled together as a slide contact guide for a transmission medium, the tapered, truncated cone-like guide inserting portion, at the time of mounting the guide to a fixed frame such as a frame of a drive unit, exhibits a wedging action for the mounting holes formed respectively in the lower side wall of the guide body and in the reinforcing plate and is thereby inserted through the mounting holes easily, whereupon the cylindrical guide support portion contiguous to the truncated cone-like guide inserting portion is fitted into the mounting holes flushly with the inner peripheral surfaces of the mounting holes and thereby supports the guide, so that the positional deviation of the mounting holes is easily corrected to surely correct the mounted state of both lower side wall and reinforcing plate.

According to the pivot shaft member in the above second aspect of the present invention, in addition to the function and effect attained in the above first aspect, since there is provided on the inserting tip side of the truncated cone-like guide inserting portion a screw portion to be threadedly engaged with the fixed frame to fix the pivot shaft member, the screw portion being smaller in diameter than the truncated cone-like guide inserting portion, first the screw portion of a smaller diameter than the truncated cone-like guide inserting portion passes through the mounting holes easily and begins to threadedly engage a fixed frame such as a frame of a drive unit, then a twisting force developed in the screw portion acts to pull the truncated cone-like guide inserting portion into the mounting holes formed respectively in the lower side wall of the guide body and the reinforcing plate, smoothly assisting the correction of a positional deviation between the mounting holes.

### BRIEF DESCRIPTION OF THE DRAWINGS

FIG. 1 is a perspective view of a pivot shaft member according to an embodiment of the present invention;

FIG. 2 is a sectional view showing an inserted state of the pivot shaft member during mounting;

FIG. 3 is a sectional view showing a supported state of the pivot shaft member after mounting;

FIG. 4 is a perspective view of a support shaft member according to another embodiment of the present invention;

FIG. 5 is an exploded perspective view of a fixed guide lever;

FIG. 6 is an exploded perspective view of a movable tensioner lever; and;

FIG. 7 is a sectional view showing a mounting defect encountered in the use of a conventional mounting bolt.

### DETAILED DESCRIPTION OF PREFERRED EMBODIMENTS

Embodiments of the present invention will be described hereinunder with reference to the drawings.

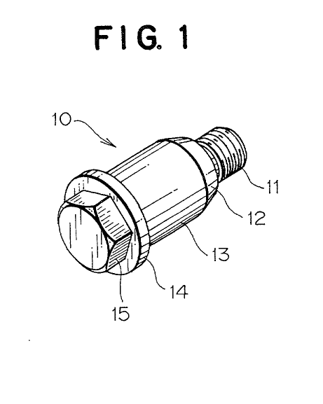

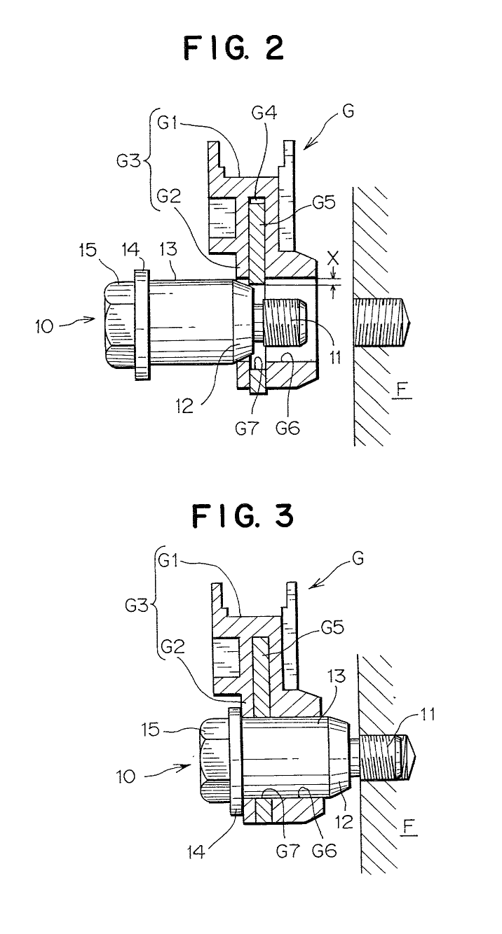

FIG. 1 is a perspective view of a pivot shaft member 10 according to a first embodiment of the present invention, FIG. 2 is a sectional view showing an inserted state of the pivot shaft member 10 in mounting a slide contact guide G for a transmission medium to a fixed frame F, and FIG. 3 is a sectional view showing a supported state of the pivot shaft member 10 after mounting.

The slide contact guide G for a transmission medium to which the pivot shaft member 10 of the first embodiment is applied is the same as the plastic guide for a transmission device disclosed in Japanese Patent Application No. 382798/2000 and functions as a movable tensioner lever which is for regulating an excessive variation in tension developed in a transmission medium such as a chain or a belt, the chain or belt being stretched between a driving side and a driven side of a drive unit such as a vehicular engine, to thereby permit a smooth travel.

More specifically, the slide contact guide G for a transmission medium, which is constituted by a movable tensioner lever, is fabricated by molding a synthetic resin integrally to form a guide body G3 and by subsequently fitting a reinforcing steel plate G5 grippingly into a slit G4 formed in a lower side wall G2 of the guide body G3. Then, the pivot shaft member of the present invention is inserted through both a mounting hole G6 formed in the lower side wall G2 and a mounting hole G7 formed in the reinforcing plate G5 and is secured to the fixed frame F such as a vehicular engine compartment.

As shown in FIG. 1, the pivot shaft member 10 of this embodiment comprises a screw portion 11 to be threadedly engaged with the fixed frame F to fix the pivot shaft member, a truncated cone-like guide inserting portion 12 which is formed contiguously to the screw portion 11 while increasing in diameter in a divergent shape from the screw portion to correct a positional deviation between the mounting holes G6 and G7, a cylindrical guide support portion 13 continguous to the truncated cone-like guide inserting portion 12 and adapted to be fitted into the mounting holes G6 and G7 flushly along inner peripheral surfaces of both holes to support the guide, an anti-dislodgment flange portion 14 formed contiguously to the cylindrical guide support portion 13 to prevent dislodgment of the slide contact guide G, and a hexahedral drive portion 15 formed continuously to the anti-dislodgment flange portion 14 so as to be driven with a wrench or the like. The screw portion 11, truncated cone-like guide inserting portion 12, the cylindrical guide support portion 13, anti-dislodgment flange portion 14, and drive portion 15 are coaxially arranged in this order from the insertion tip side toward the rear end on the mounting side.

Now, with reference to FIGS. 2 and 3, the following description is provided about mounting the slide contact guide G for a transmission medium constituted by a movable tensioner lever to the fixed frame F such as a vehicular engine room with use of the pivot shaft member 10 of this embodiment.

As shown in FIGS. 2 and 3, when the screw portion 11 of the pivot shaft member 10 of this embodiment comes into abutment against the fixed frame F through the mounting holes G6 and G7 of the slide contact guide G and begins to engage the frame F threadedly, a twisting force developed in the screw portion 11 acts to pull the truncated cone-like guide inserting portion 12 into the mounting holes G6 and G7 formed in the guide body G3 and the reinforcing plate G5 respectively, so that the truncated cone-like guide inserting portion 12 exhibits a wedging action for the mounting holes G6 and G7, whereby a positional deviation X between the mounting holes G6 and G7 is corrected easily.

Next, as the screw portion 11 is inserted threadedly while ensuring the corrected state of the positional deviation X, as shown in FIG. 3, the cylindrical guide support portion 13 is fitted into the mounting holes G6 and G7 flushly with the inner peripheral surfaces of the mounting holes to support the guide.

Therefore, in the case where the slide contact guide G for a transmission medium, which is constituted by a movable tensioner lever, is mounted to the fixed frame F using the pivot shaft member 10 of this embodiment, the positional deviation X between the mounting holes G6 and G7 of the slide contact guide G is corrected easily with the twisting force developed at the time of installation to positively correct the mounted state between the lower side wall G2 and the reinforcing plate G5. Therefore, the mounting work is effected in a positive and simple manner without such damage of the mounting hole G6 or mounting error as in the prior art, whereby the mounting burden can be greatly diminished. Besides, since the cylindrical guide support portion 13 is fitted into the mounting holes G6 and G7 flushly with the inner peripheral surfaces of the mounting holes to support the guide, it is possible to eliminate a partial wear of the surface of the shoe G1 with which a travelling transmission medium such as a travelling chain or belt comes into sliding contact and thereby possible to ensure the slide contact function of the slide contact guide G and ensure a long guide life. Besides, the pivot shaft member can full exhibit its pivoting function as a fulcrum for following an excessive variation in tension of a travelling chain or belt to regulate the tension of the chain or belt.

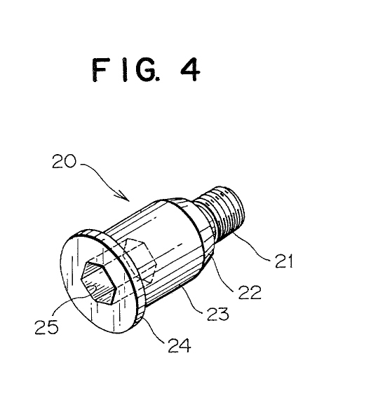

FIG. 4 is a perspective view of a pivot shaft member 20 according to a second embodiment of the present invention. In the pivot shaft member 20 of this embodiment, which shows a modification, the clamp portion 15 of the pivot shaft member 10 in the previous first embodiment is formed as a drive portion 25 which is a hexagonal hole formed in the interiors of both anti-dislodgment flange portion 14 and cylindrical guide support portion 13. As to other portions, the pivot shaft member 20 of this embodiment, like the pivot shaft member 10 of the first embodiment, is also provided with a screw portion 21, a truncated cone-like guide inserting portion 22, a cylindrical guide support portion 23, and an anti-dislodgment flange portion 24, and basic mounting functions are also the same as in the first embodiment. But the pivot shaft member 20 can be made smaller in size than the pivot shaft member 10 of the first embodiment.

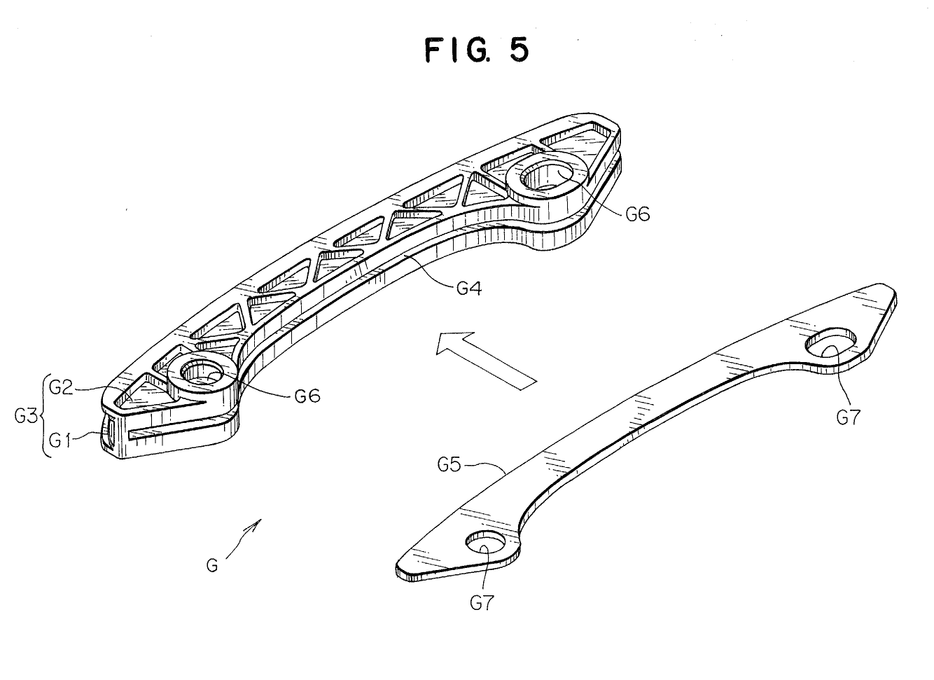

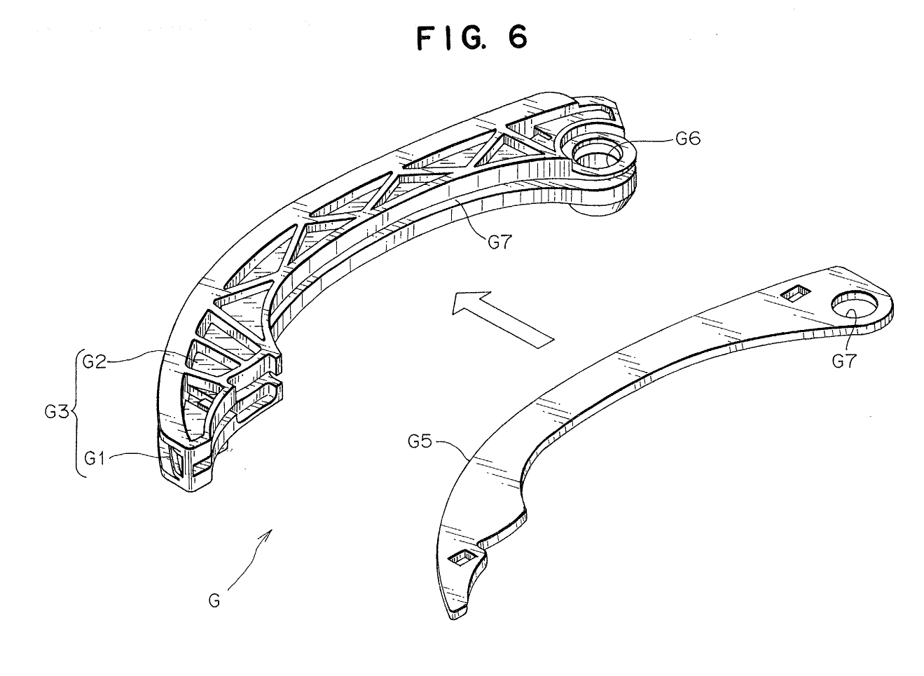

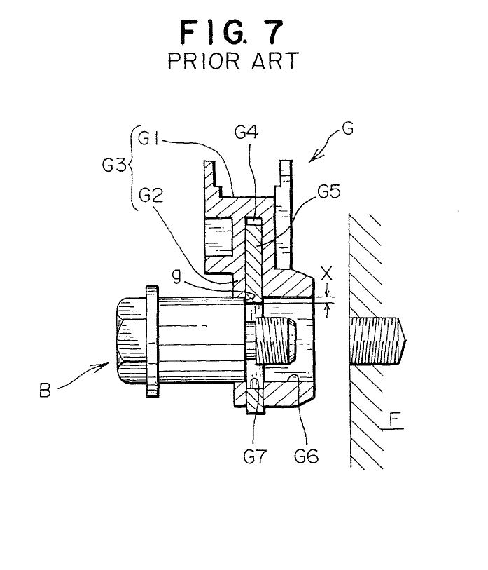

The slide contact guide G for a transmission medium, to which the pivot shaft member of the present invention is applied, is a fixed guide lever for preventing chordal vibration and rolling from being generated in a transmission medium such as a chain or belt stretched between a driving side and a driven side of a drive unit, thereby permitting a smooth travel. Also in such a fixed guide lever, as in the foregoing movable tensioner lever, a guide body G3 is formed integrally by molding a synthetic resin, the guide body G3 being composed of a shoe G1 with which a travelling transmission medium such as a travelling chain or belt comes into sliding contact and a lower side wall G2 formed on the back side of the shoe G1 in the shape of a vertical plate extending longitudinally, and a reinforcing plate G5 made of steel is fitted grippingly into a slit G4 formed in the lower side wall G2 of the guide body G3. The guide G thus fabricated is secured to the fixed frame such as a vehicular engine compartment through mounting holes G6 and G7 formed in the lower side wall G2 and the reinforcing plate G5 respectively. Thus, the pivot shaft member 10 of the first embodiment or the pivot shaft member 20 of the second embodiment in the present invention is applicable to the slide contact guide G shown in FIG. 5.

As set forth above, the pivot shaft member for a slide contact guide for a transmission medium according to the present invention can be mounted to a fixed frame such as a frame of a drive unit even if there is a positional deviation between mounting holes formed respectively in a lower side wall of the body of the guide as fabricated and in a reinforcing plate. Particularly, the pivot shaft member brings about the following effects peculiar to the present invention.

According to the pivot shaft member in the first aspect of the present invention, when the guide is to be mounted to a fixed frame such as a frame of a drive unit, the tapered, truncated cone-like guide inserting portion of the pivot shaft member exhibits a wedging action for the mounting holes formed in the lower side wall and the reinforcing plate respectively and thus can be easily inserted through the mounting holes, whereby a positional deviation between the mounting holes is corrected easily and hence a mounted state between the lower side wall and the reinforcing plate is surely corrected. Thus, without such damage of the mounting holes and mounting error as in the prior art, the mounting work can be effected in a positive and simple manner and hence it is possible to greatly diminish the mounting burden.

Moreover, according to the pivot shaft member in the first aspect of the present invention, the cylindrical guide support portion, which is contiguous to the truncated cone-like guide insertion portion, is fitted into the mounting holes flushly with the inner surfaces of the mounting holes to support the guide, so that it is possible to eliminate a partial wear of the shoe surface with which a travelling transmission medium such as a travelling chain or belt comes into sliding contact and therefore possible to ensure both contact slide function of the guide and guide life over a long period. Particularly, in the case where the plastic guide for a transmission device is a movable tensioner lever, the pivot shaft member can satisfactorily fulfill its pivoting function as a fulcrum for following an excessive variation in tension of a travelling chain or belt to regulate the tension.

Further, according to the pivot shaft member in the second aspect of the present invention, in addition to the effects attained by the pivot shaft member in the first aspect, since a screw portion smaller in diameter than the truncated cone-like guide inserting portion, which is for threaded engagement with a fixed frame such as a frame of a drive unit to fix the pivot shaft member, is provided on the inserting tip side of the truncated cone-like guide inserting portion, a twisting force developed in the screw portion when the screw portion begins to threadedly engage the fixed frame acts to pull the truncated cone-like guide inserting portion into the mounting holes formed in the lower side wall of the guide body and the reinforcing plate respectively. In this way the labor required for correcting a positional deviation between the mounting holes can be diminished and a smooth travel is ensured.

What is claimed is:

1. A pivot shaft member for a slide contact guide for a transmission medium, said pivot shaft member being to be inserted and fixed through mounting holes formed respectively in a longitudinally extending lower side wall of a guide body of the slide contact guide and in a reinforcing plate for fixing the slide contact guide to a fixed frame, said slide contact guide comprising said guide body and said reinforcing plate, said guide body having an elongated shoe surface with which a travelling transmission medium such as a travelling chain or belt comes into sliding contact, said reinforcing plate being grippingly fitted along and into said lower side wall of said guide body,
characterized by including a tapered, truncated cone-like guide inserting portion and a cylindrical guide support portion, said truncated cone-like guide inserting portion being inserted, at the time of mounting the guide, into said mounting holes while correcting a positional deviation between the mounting holes, and said cylindrical support portion being contiguous to said truncated cone-like guide inserting portion and onto which inner peripheral surfaces of said mounting holes are flushly fitted and supported after the mounting of the guide.

2. A pivot shaft member for a slide contact guide for a transmission medium according to claim 1, wherein a screw portion smaller in diameter than said truncated cone-like guide inserting portion and adapted to be threadedly engaged with the fixed frame to fix the pivot shaft member is formed on an inserting tip side of said truncated cone-like guide inserting portion.
